(19) United States
(12) Patent Application Publication
(10) Pub. No.: US 2014/0122722 A1
(43) Pub. Date: May 1, 2014

(54) ALLOCATION OF RESOURCES IN A NETWORKED COMPUTING ENVIRONMENT

(71) Applicant: International Business Machines Corporation, (US)

(72) Inventors: Eitan D. Farchi, Pardes-Hana (IL); Aharon Kupershtok, Ramat Gan (IL); Onn M. Shehory, Yahud-Monosson (IL)

(73) Assignee: International Business Machines Corporation, Armonk, NY (US)

(21) Appl. No.: 13/662,575

(22) Filed: Oct. 29, 2012

(51) Int. Cl. G06F 15/173

(52) U.S. Cl. 709/226

(57) ABSTRACT

Systems and methods for resource allocation in a network are provided. In one embodiment, the method comprises generating one or more workload parameters for one or more components in a network comprising a plurality of network nodes, wherein a network node comprises a plurality of the components; allocating one or more resources to the one or more components; and modifying the one or more workload parameters for the one or more components, in response to determining that one or more predetermined performance goals are not optimally supported for at least one of the plurality of network nodes.

### COPYRIGHT & TRADEMARK NOTICES

A portion of the disclosure of this patent document may contain material, which is subject to copyright protection. The owner has no objection to the facsimile reproduction by any one of the patent document or the patent disclosure, as it appears in the Patent and Trademark Office patent file or records, but otherwise reserves all copyrights whatsoever.

Certain marks referenced herein may be common law or registered trademarks of the applicant, the assignee or third parties affiliated or unaffiliated with the applicant or the assignee. Use of these marks is for providing an enabling disclosure by way of example and shall not be construed to exclusively limit the scope of the disclosed subject matter to material associated with such marks.

### TECHNICAL FIELD

The disclosed subject matter relates generally to the allocation of resources in a computing network and, more particularly, to achieving optimal resource allocation in a computing network.

### BACKGROUND

To improve performance in a computing network, the capacity and availability of various network resources and the bandwidth limitations among the network nodes, where the resources reside, may be monitored and adjusted. Resources may include network components or nodes that provide a service (e.g., storage or computing services). The nodes generally communicate over ports and network components that support a connection with other nodes at a certain bandwidth and speed.

In some networks where resource capacity is limited, in order to guarantee performance, the resources are typically under-allocated. Such under-allocation can result in some resources remaining idle and leads to waste. In some networks, to achieve better throughput from the system as a whole, the resources may be overly-allocated. Such over-allocation may adversely affect system performance, however, as some resources may not have the capacity to handle all submitted requests during a heavy use window.

Optimization schemes have been introduced to try to balance resource allocation in a networked computing environment in a way to avoid the negative consequences of over- or under-provisioning. Where the interconnection bandwidth among network nodes that host the resources is limited or the hosts provide multiple types of resources, proper resource optimization can become a challenging endeavor.

### SUMMARY

For purposes of summarizing, certain aspects, advantages, and novel features have been described herein. It is to be understood that not all such advantages may be achieved in accordance with any one particular embodiment. Thus, the disclosed subject matter may be embodied or carried out in a manner that achieves or optimizes one advantage or group of advantages without achieving all advantages as may be taught or suggested herein.

Machines, systems and methods for resource allocation in a network are provided. In one embodiment, the method comprises generating one or more workload parameters for one or more components in a network comprising a plurality of network nodes, wherein a network node comprises a plurality of the components; allocating one or more resources to the one or more components; and modifying the one or more workload parameters for the one or more components, in response to determining that one or more predetermined performance goals are not optimally supported for at least one of the plurality of network nodes.

In accordance with one or more embodiments, a system comprising one or more logic units is provided. The one or more logic units are configured to perform the functions and operations associated with the above-disclosed methods. In yet another embodiment, a computer program product comprising a computer readable storage medium having a computer readable program is provided. The computer readable program when executed on a computer causes the computer to perform the functions and operations associated with the above-disclosed methods.

One or more of the above-disclosed embodiments in addition to certain alternatives are provided in further detail below with reference to the attached figures. The disclosed subject matter is not, however, limited to any particular embodiment disclosed.

### BRIEF DESCRIPTION OF THE DRAWINGS

The disclosed embodiments may be better understood by referring to the figures in the attached drawings, as provided below.

FIG. 1 illustrates an exemplary computing network with two or more network nodes, in accordance with one or more embodiments, in which some network nodes communicate via an interconnect.

FIG. 2 is a flow diagram of an exemplary method for iteratively allocating resources, in accordance with one or more embodiments.

FIGS. 3A and 3B are block diagrams of hardware and software environments in which the disclosed systems and methods may operate, in accordance with one or more embodiments.

Features, elements, and aspects that are referenced by the same numerals in different figures represent the same, equivalent, or similar features, elements, or aspects, in accordance with one or more embodiments.

### DETAILED DESCRIPTION OF EXAMPLE EMBODIMENTS

In the following, numerous specific details are set forth to provide a thorough description of various embodiments. Certain embodiments may be practiced without these specific details or with some variations in detail. In some instances, certain features are described in less detail so as not to obscure other aspects. The level of detail associated with each of the elements or features should not be construed to qualify the novelty or importance of one feature over the others.

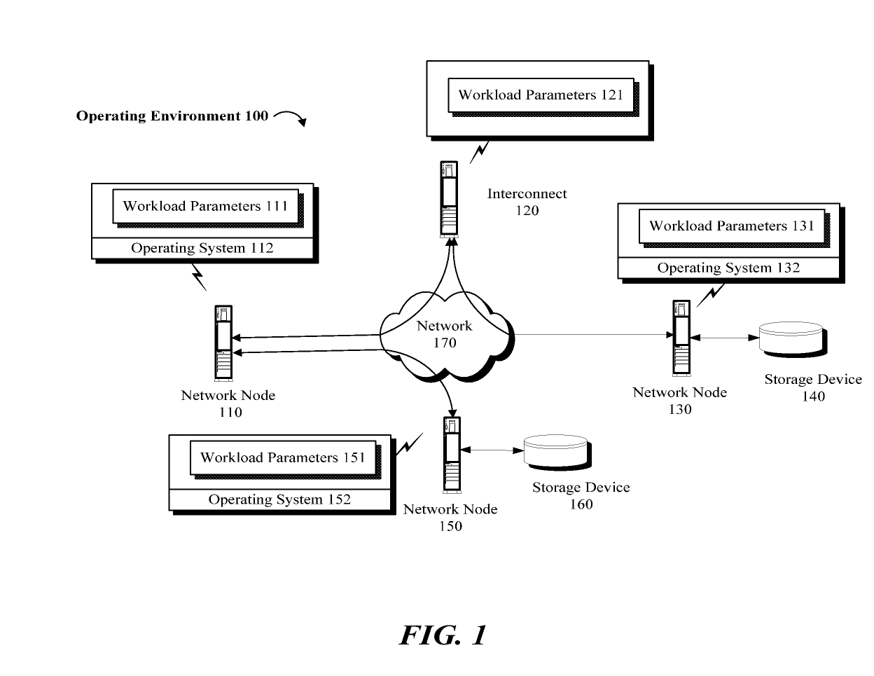

Referring to FIG. 1, an exemplary operating environment 100 is illustrated. In one embodiment, network node 110 communicates directly with network node 150 over network 170. As shown, network node 110 may also communicate with network node 130 via an interconnect 120 over network 170. It is noteworthy that interconnect 120 between network node 110 and network node 130 may comprise a network component (e.g., a communication router or a switch) that manages communication between a plurality of nodes in network 170.

In accordance with one embodiment, network node 150 is connected to a storage device 160 which may be accessed by network node 110 over network 170. In this example, storage device 160 may be locally attached to network node 150 and remotely attached to network node 110. In a similar manner, network node 130 may be connected to a storage device 140 either directly or in a local network, where storage device 140 may be remotely accessed by other network nodes or components over interconnect 120 in network 170.

As provided in further detail below, a network node may be associated with workload parameters that provide information about the capacity and nature of resources available on that node. Workload parameters 111 for network node 110, for example, may indicate that network node 110 has several available resources (e.g., computing, memory and disk storage) and in addition provide information about the capacity or the available capacity of each resource. For example, given a set of workloads, a workload may be represented by the following vector (CPU util., CPU-memory tp., memory util., network tp., DAS tp. NAS tp., FC tp.).

In accordance with one embodiment, network nodes 130 and 150 may act as servers. For example, the storage devices 140 and 160 that are directly attached to the network node 130 and 150, respectively, may be shared with network node 110. Depending on implementation, a plurality of destination network nodes (e.g., network nodes 130 and 150) may act as a single logical server. As such, the workload parameters of a plurality of destination network nodes (e.g., those of network nodes 130 and 150) may be logically consolidated for the purpose of performing resource allocation.

It is noteworthy that the interconnect 120 may also be associated with a set of workload parameters 121 (e.g., interconnect bandwidth capacity or data transfer rate). As such, during resource allocation, the workload parameters of the interconnect 120 and other interconnects in the network may be also considered. That is, in one implementation, interconnect 120 may be treated as a node in the network for the purpose of considering the associated workload parameters 121, even though interconnect 120 functions primarily to support data transfer between network nodes 110, 130, etc.

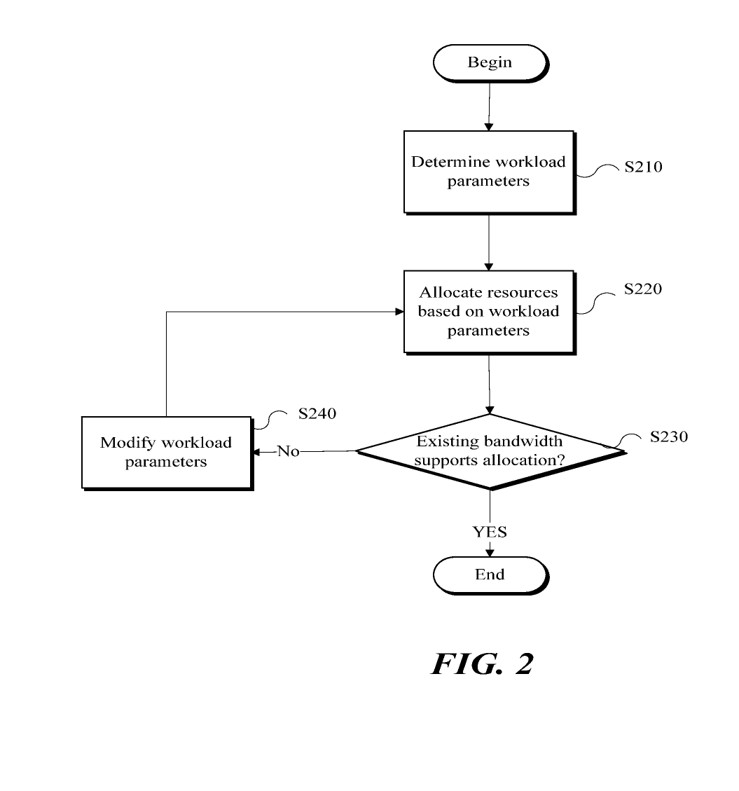

Referring to FIG. 2, in accordance with one embodiment, workload parameters for the various nodes and interconnects in network may be determined in order to plan the allocation of resources in an optimum manner (S210). In a first phase, the resources may be allocated based on the workload parameters for the nodes that host the resources without taking into account the workload parameters associated with the interconnects (S220). For example, a resource allocation scheme may be used to distribute the workload among various resources available on a plurality of nodes based on the number or available capacity of computing, memory or disk storage resources in network 170.

In a second phase, the interconnect infrastructure and the data flow architecture among the nodes in network 170 may be analyzed to determine whether the limited bandwidth supported by the existing interconnects in the network 170 is sufficient to handle the demands on the interconnects when the resources as allocated in the first phase are utilized (S230). The above analysis may take place prior to the utilization of resources and in certain embodiments prior to the actual allocation of the resources. That is, for the purpose of efficiency, the resource allocation in the first phase may be performed virtually.

Accordingly, taking into account certain performance goals, it may be determined whether a resulting resource allocation (e.g., a virtual allocation of resources in network 170) is optimal. In one implementation, the allocation may be deemed optimal where certain performance goals are met and the existing bandwidth for the interconnects in network 170 supports the calculated resource allocation. If, however, it is determined that the allocation is not optimal, the workload parameters for the resources in network 170 may be modified to, for example, reduce the associated interconnect bandwidth among nodes to achieve a better optimization (S240).

In one example implementation, workload parameters related to resource capacity associated with a network node may be artificially reduced to lessen the amount of resources that may be allocated to one or more workloads, when the first phase is repeated, as shown in FIG. 2 (see loop back from S240 to S220). An artificial reduction in the capacity of a resource would effectively result in a lesser amount of demand for resources being directed to a corresponding network node. As such, a lesser amount of bandwidth would be needed to support the interconnection between that node and other nodes in network 170.

Once the workload parameters are modified (S240), then the resource allocation scheme in the first phase is repeated (S220). As noted earlier, the resource allocation may be virtually performed and the result may be analyzed to determine whether the actual interconnect bandwidth (in contrast to the artificially reduced interconnect bandwidth) is capable of supporting the new allocation of resources (S230). It is noteworthy that the notion of an artificial reduction in capacity in the context of this disclosure means that a resource is designated as capable of handling less than what that resource is actually capable of handling.

Referring back to FIG. 2, if the new allocation (at S230) satisfies the workload and bandwidth constraints, then the new allocation is applied. Otherwise, the workload parameters are modified again and the process associated with the first and second phases provided above are repeated until the gradual artificial reduction in interconnect bandwidth results in an acceptable allocation of resources. Depending on the particular details of the system and the various workload parameters and resource or interconnect availability and capacity, the above processes may not lead to a solution which would ultimately mean that optimization for the resource allocation has been unsuccessful.

Workload parameters for a network resource may include the physical and logical constraints associated with that resource and the structural and functional attributes of the node that hosts the resources (e.g., CPU utilization, CPU type, memory utilization, memory type, direct attached disk type, network attached disk type, fiber channel disk type, etc.). The workload parameters may be generated manually or automatically based on past workloads, or based on workload benchmarks. A set of example workloads is presented below.

| (period, | CPU util, | mem tp, | mem util, | NAS disk tp, | FC disk tp, | network tp) |
|---|---|---|---|---|---|---|
| (AM, | 50%, | 40%, | 40%, | 0.2 GB/s, | 0.1 GB/s, | 0.2 GB/s) |
| (AM, | 40%, | 70%, | 40%, | 0.1 GB/s, | 0.2 GB/s, | 0.1 GB/s) |
| (AM, | 30%, | 50%, | 40%, | 0.2 GB/s, | 0.1 GB/s, | 0.2 GB/s) |
| (PM, | 40%, | 30%, | 30%, | 2.5 GB/s, | 0.5 GB/s, | 1.5 GB/s) |
| (PM, | 20%, | 20%, | 30%, | 1.0 GB/s, | 0.4 GB/s, | 2.0 GB/s) |
| (PM, | 10%, | 30%, | 30%, | 1.0 GB/s, | 0.6 GB/s, | 2.5 GB/s) |

In accordance with one example embodiment, a bin packing algorithm may be used in the first phase noted earlier for the purpose of allocation of resources based to target workloads. In such implementation, one or more components of a network node may be assigned to a bin in the bin packing algorithm. An exemplary non-limiting pseudo-code for a bin packing algorithm is presented below for the purpose of illustration and without detracting from the scope of the claimed subject matter:

```
Input:
A given set of server workloads. Target platform unique properties and constraints
(including interconnect constraints).
Output:
Suggested optimal configuration by means of minimal allocated resources.
An Exemplary pseudo-code:
decrease amount <--- CONST between 0 and 1
routingStatus <--- FALSE
while ( routingStatus == FALSE ) do
{
  // Three dimensional vector bin packing.
  // The items to be packed are triplets --- ( cpu utilization, cpu-memory bus
utilization, memory utilization ).
  // Every bin has three dimensional capacity ---
  // ( cpu max allowed utilization, cpu-memory bus max allowed utilization, memory
max allowed utilization ).
  // The capacity should be the same across all dimensions. Also the unit type across all
dimensions should be
    // the same.
  // In case that a type of workload (that is, one dimension in the triplet) is unknown
across all triplets,
  // its value in the triplet is set to zero across all triplets.
  // For example, if cpu-memory bus utilization is not measured (and therefore
unknown), it is set to zero in all
  // triplets.
  TripleDimVectorBinPacking ( input: cpu utilization, cpu max allowed utilization,
```

cpu-memory bus utilization, cpu-memory bus max

allowed utilization,

memory utilization, memory max allowed utilization

output: number of CPUs, cpu workload assigned to cpu

```
number );
  // Scalar bin packing.
  // The items to be packed are scalars --- FC throughput.
  // Every bin has a max capacity equal to the FC port max allowed throughput
  ScalarBinPacking ( input: FC throughput, FC port max allowed throughput
              output: number of FC ports, FC throughput assigned to FC port
number );
  // Scalar bin packing.
  // The items to be packed are scalars --- Ethernet throughput.
  // Every bin has a max capacity equal to the Ethernet port max allowed throughput
  ScalarBinPacking ( input: Ethernet throughput, Ethernet port max allowed
throughput
              output: number of Ethernet ports, Ethernet throughput assigned to
Ethernet port number );
  // Aptus interconnect is represented by a graph.
  // Every node in the graph represents a component ( e.g. ITE, switch, NIC, FC HBA )
in the interconnect.
  // Every edge in the graph represents a link in the interconnect.
  // Every cpu workload that is assigned to a cpu, is also assigned to a node in the
graph.
  // Every FC throughput that is assigned to FC port, is also assigned to a node in the
graph.
  // Every Ethernet throughput that is assigned to Ethernet port, is also assigned to a
node in the graph.
  AssignWorkloadsToAptusNodes ( input: cpu workload assigned to cpu number,
```

FC throughput assigned to FC port number
Ethernet throughput assigned to Ethernet port

number

output: cpu workload assigned to node number,

FC throughput assigned to FC node number
Ethernet throughput assigned to Ethernet node

```
number );
  // Initiate a matrix that represent the graph
  InitiateAptusMatrix ( input/output: aptusMatrix );
  // For every server workload --- ( cpu utilization, cpu-memory bus utilization,
memory utilization,
  // FC throughput, Ethernet throughput ) with corresponding throughput requirements,
  // update aptus matrix accordingly.
  // The output routing status, tells whether APTUS interconnect can accommodate the
aggregation of the different thorughput.
  CreateAptusRouting ( input: aptusMatrix,
```

cpu workload assigned to node number,
FC throughput, FC throughput assigned to FC node number
Ethernet throughput, Ethernet throughput assigned to

Ethernet node number

output: routingStatus );

```
  if ( routingStatus == FALSE )
  {
        cpu max allowed utilization <--- cpu max allowed utilization - decrease
amount
        cpu-memory bus max allowed utilization <--- cpu-memory bus max allowed
utilization - decrease amount
        memory max allowed utilization <--- memory max allowed utilization -
decrease amount
        FC port max allowed throughput <--- FC port max allowed throughput -
decrease amount
        Ethernet port max allowed throughput <--- Ethernet port max allowed
throughput - decrease amount
  }
}
```

In accordance with one implementation, a maximum flow minimum cut algorithm may be used in the second phase to determine whether the interconnect bandwidths in a network optimally support predetermined performance goals. The maximum flow minimum cut algorithm is useful in finding the bottlenecks in the network 170. As such, the modification of workload parameters may be performed in such a way to minimize or eliminate the bottlenecks.

References in this specification to “an embodiment”, “one embodiment”, “one or more embodiments” or the like, mean that the particular element, feature, structure or characteristic being described is included in at least one embodiment of the disclosed subject matter. Occurrences of such phrases in this specification should not be particularly construed as referring to the same embodiment, nor should such phrases be interpreted as referring to embodiments that are mutually exclusive with respect to the discussed features or elements.

In different embodiments, the claimed subject matter may be implemented as a combination of both hardware and software elements, or alternatively either entirely in the form of hardware or entirely in the form of software. Further, computing systems and program software disclosed herein may comprise a controlled computing environment that may be presented in terms of hardware components or logic code executed to perform methods and processes that achieve the results contemplated herein. Said methods and processes, when performed by a general purpose computing system or machine, convert the general purpose machine to a specific purpose machine.

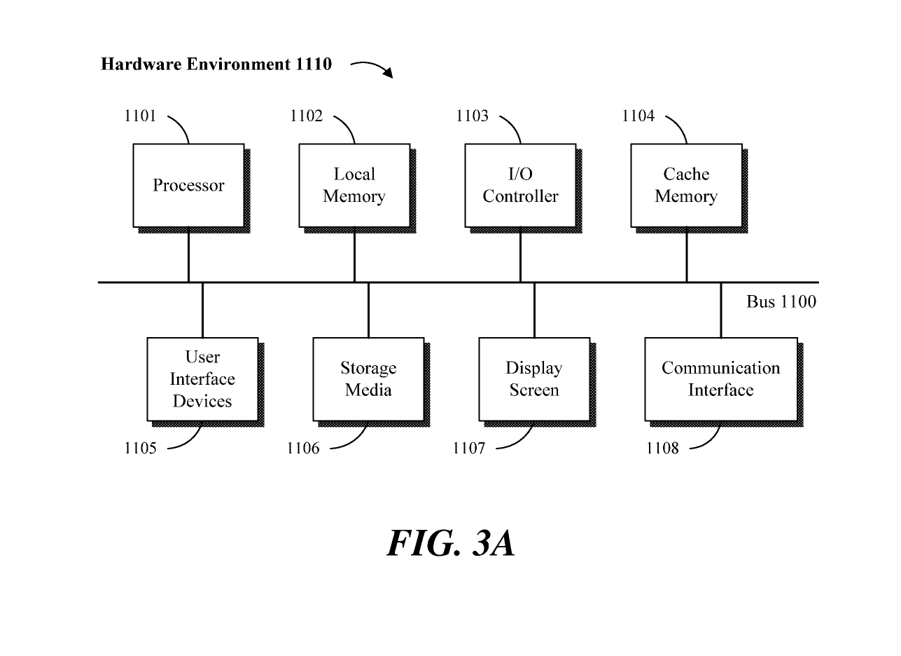

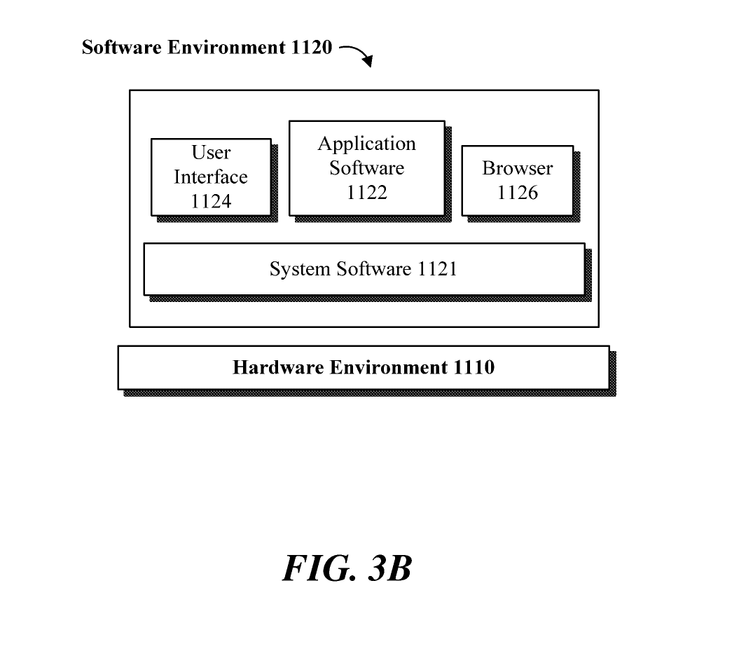

Referring to FIGS. 3A and 3B, a computing system environment in accordance with an exemplary embodiment may be composed of a hardware environment 1110 and a software environment 1120. The hardware environment 1110 may comprise logic units, circuits or other machinery and equipments that provide an execution environment for the components of software environment 1120. In turn, the software environment 1120 may provide the execution instructions, including the underlying operational settings and configurations, for the various components of hardware environment 1110.

Referring to FIG. 3A, the application software and logic code disclosed herein may be implemented in the form of machine readable code executed over one or more computing systems represented by the exemplary hardware environment 1110. As illustrated, hardware environment 110 may comprise a processor 1101 coupled to one or more storage elements by way of a system bus 1100. The storage elements, for example, may comprise local memory 1102, storage media 1106, cache memory 1104 or other machine-usable or computer readable media. Within the context of this disclosure, a machine usable or computer readable storage medium may include any recordable article that may be utilized to contain, store, communicate, propagate or transport program code.

A computer readable storage medium may be an electronic, magnetic, optical, electromagnetic, infrared, or semiconductor medium, system, apparatus or device. The computer readable storage medium may also be implemented in a propagation medium, without limitation, to the extent that such implementation is deemed statutory subject matter. Examples of a computer readable storage medium may include a semiconductor or solid-state memory, magnetic tape, a removable computer diskette, a random access memory (RAM), a read-only memory (ROM), a rigid magnetic disk, an optical disk, or a carrier wave, where appropriate. Current examples of optical disks include compact disk, read only memory (CD-ROM), compact disk read/write (CD-R/W), digital video disk (DVD), high definition video disk (HD-DVD) or Blue-Ray™ disk.

In one embodiment, processor 1101 loads executable code from storage media 1106 to local memory 1102. Cache memory 1104 optimizes processing time by providing temporary storage that helps reduce the number of times code is loaded for execution. One or more user interface devices 1105 (e.g., keyboard, pointing device, etc.) and a display screen 1107 may be coupled to the other elements in the hardware environment 1110 either directly or through an intervening I/O controller 1103, for example. A communication interface unit 1108, such as a network adapter, may be provided to enable the hardware environment 1110 to communicate with local or remotely located computing systems, printers and storage devices via intervening private or public networks (e.g., the Internet). Wired or wireless modems and Ethernet cards are a few of the exemplary types of network adapters.

It is noteworthy that hardware environment 1110, in certain implementations, may not include some or all the above components, or may comprise additional components to provide supplemental functionality or utility. Depending on the contemplated use and configuration, hardware environment 1110 may be a machine such as a desktop or a laptop computer, or other computing device optionally embodied in an embedded system such as a set-top box, a personal digital assistant (PDA), a personal media player, a mobile communication unit (e.g., a wireless phone), or other similar hardware platforms that have information processing or data storage capabilities.

In some embodiments, communication interface 1108 acts as a data communication port to provide means of communication with one or more computing systems by sending and receiving digital, electrical, electromagnetic or optical signals that carry analog or digital data streams representing various types of information, including program code. The communication may be established by way of a local or a remote network, or alternatively by way of transmission over the air or other medium, including without limitation propagation over a carrier wave.

As provided here, the disclosed software elements that are executed on the illustrated hardware elements are defined according to logical or functional relationships that are exemplary in nature. It should be noted, however, that the respective methods that are implemented by way of said exemplary software elements may be also encoded in said hardware elements by way of configured and programmed processors, application specific integrated circuits (ASICs), field programmable gate arrays (FPGAs) and digital signal processors (DSPs), for example.

Referring to FIG. 3B, software environment 1120 may be generally divided into two classes comprising system software 1121 and application software 1122 as executed on one or more hardware environments 1110. In one embodiment, the methods and processes disclosed here may be implemented as system software 1121, application software 1122, or a combination thereof. System software 1121 may comprise control programs, such as an operating system (OS) or an information management system, that instruct one or more processors 1101 (e.g., microcontrollers) in the hardware environment 1110 on how to function and process information. Application software 1122 may comprise but is not limited to program code, data structures, firmware, resident software, microcode or any other form of information or routine that may be read, analyzed or executed by a processor 1101.

In other words, application software 1122 may be implemented as program code embedded in a computer program product in form of a machine-usable or computer readable storage medium that provides program code for use by, or in connection with, a machine, a computer or any instruction execution system. Moreover, application software 1122 may comprise one or more computer programs that are executed on top of system software 1121 after being loaded from storage media 1106 into local memory 1102. In a client-server architecture, application software 1122 may comprise client software and server software. For example, in one embodiment, client software may be executed on a client computing system that is distinct and separable from a server computing system on which server software is executed.

Software environment 1120 may also comprise browser software 1126 for accessing data available over local or remote computing networks. Further, software environment 1120 may comprise a user interface 1124 (e.g., a graphical user interface (GUI)) for receiving user commands and data. It is worthy to repeat that the hardware and software architectures and environments described above are for purposes of example. As such, one or more embodiments may be implemented over any type of system architecture, functional or logical platform or processing environment.

It should also be understood that the logic code, programs, modules, processes, methods and the order in which the respective processes of each method are performed are purely exemplary. Depending on implementation, the processes or any underlying sub-processes and methods may be performed in any order or concurrently, unless indicated otherwise in the present disclosure. Further, unless stated otherwise with specificity, the definition of logic code within the context of this disclosure is not related or limited to any particular programming language, and may comprise one or more modules that may be executed on one or more processors in distributed, non-distributed, single or multiprocessing environments.

As will be appreciated by one skilled in the art, a software embodiment may include firmware, resident software, micro-code, etc. Certain components including software or hardware or combining software and hardware aspects may generally be referred to herein as a “circuit,” “module” or “system.” Furthermore, the subject matter disclosed may be implemented as a computer program product embodied in one or more computer readable storage medium(s) having computer readable program code embodied thereon. Any combination of one or more computer readable storage medium(s) may be utilized. The computer readable storage medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing.

In the context of this document, a computer readable storage medium may be any tangible medium that can contain, or store a program for use by or in connection with an instruction execution system, apparatus, or device. A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable storage medium may be transmitted using any appropriate medium, including but not limited to wireless, wireline, optical fiber cable, RF, etc., or any suitable combination of the foregoing. Computer program code for carrying out the disclosed operations may be written in any combination of one or more programming languages, including an object oriented programming language such as Java, Smalltalk, C++ or the like and conventional procedural programming languages, such as the “C” programming language or similar programming languages.

The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Certain embodiments are disclosed with reference to flowchart illustrations or block diagrams of methods, apparatus (systems) and computer program products according to embodiments. It will be understood that each block of the flowchart illustrations or block diagrams, and combinations of blocks in the flowchart illustrations and/or block diagrams, can be implemented by computer program instructions. These computer program instructions may be provided to a processor of a general purpose computer, a special purpose machinery, or other programmable data processing apparatus to produce a machine, such that the instructions, which execute via the processor of the computer or other programmable data processing apparatus, create means for implementing the functions or acts specified in the flowchart or block diagram block or blocks.

These computer program instructions may also be stored in a computer readable storage medium that can direct a computer, other programmable data processing apparatus, or other devices to function in a particular manner, such that the instructions stored in the computer readable storage medium produce an article of manufacture including instructions which implement the function or act specified in the flowchart or block diagram block or blocks.

The computer program instructions may also be loaded onto a computer, other programmable data processing apparatus, or other devices to cause a series of operational steps to be performed on the computer, other programmable apparatus or other devices to produce a computer or machine implemented process such that the instructions which execute on the computer or other programmable apparatus provide processes for implementing the functions or acts specified in the flowchart or block diagram block or blocks.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical functions. It should also be noted that, in some alternative implementations, the functions noted in the block may occur in any order or out of the order noted in the figures.

For example, two blocks shown in succession may, in fact, be executed substantially concurrently, or the blocks may sometimes be executed in the reverse order, depending upon the functionality involved. It will also be noted that each block of the block diagrams or flowchart illustration, and combinations of blocks in the block diagrams or flowchart illustration, may be implemented by special purpose hardware-based systems that perform the specified functions or acts, or combinations of special purpose hardware and computer instructions.

The claimed subject matter has been provided here with reference to one or more features or embodiments. Those skilled in the art will recognize and appreciate that, despite of the detailed nature of the exemplary embodiments provided here, changes and modifications may be applied to said embodiments without limiting or departing from the generally intended scope. These and various other adaptations and combinations of the embodiments provided here are within the scope of the disclosed subject matter as defined by the claims and their full set of equivalents.

What is claimed is:

1. A resource allocation method comprising:
generating one or more workload parameters for one or more components in a network comprising a plurality of network nodes, wherein a network node comprises a plurality of the components;
allocating one or more resources to the one or more components; and
modifying the one or more workload parameters for the one or more components, in response to determining that one or more predetermined performance goals are not optimally supported for at least one of the plurality of network nodes.

2. The method of claim 1, wherein a bin packing algorithm is used to allocate the resources to the components.

3. The method of claim 1, wherein a maximum flow minimum cut algorithm is used in determining whether the one or more predetermined performance goals are not optimally supported.

4. The method of claim 1, wherein modifying the one or more workload parameters for the one or more components comprises reducing the one or more workload parameters by a constant number.

5. The method of claim 1, wherein modifying the one or more workload parameters for one or more components comprises reducing the one or more workload parameters by a constant percentage.

6. The method of claim 5, wherein number of links connecting two or more of the plurality of network nodes is increased.

7. The method of claim 1 wherein a component comprises at least one of CPU, memory or disk.

8. The method of claim 7, wherein the disk comprises at least one of a direct attached disk, network attached disk or fiber channel disk.

9. The method of claim 1, wherein the workload parameter comprises at least one of CPU utilization or memory utilization.

10. The method of claim 1, wherein the workload parameter comprises at least one of memory tp., disk tp. or network tp.

11. A resource allocation system comprising:
a logic unit for generating one or more workload parameters for one or more components in a network comprising a plurality of network nodes, wherein a network node comprises a plurality of components;
a logic unit for allocating one or more resources to the one or more components; and
a logic unit for modifying the one or more workload parameters for the one or more components, in response to determining that one or more predetermined performance goals are not optimally supported for at least one of the plurality of network nodes.

12. The system of claim 11, wherein a bin packing algorithm is used to allocate the resources to the components.

13. The system of claim 11, wherein a maximum flow minimum cut algorithm is used in determining whether the one or more predetermined performance goals are not optimally supported.

14. The system of claim 11, wherein modifying the one or more workload parameters for the one or more components comprises reducing the one or more workload parameters by a constant number.

15. The system of claim 11, wherein modifying the one or more workload parameters for one or more components comprises reducing the one or more workload parameters by a constant percentage.

16. A computer program product comprising a tangible computer readable storage medium having a computer readable program, wherein the computer readable program when executed on a computer causes the computer to:
generate one or more workload parameters for one or more components in a network comprising a plurality of network nodes, wherein a network node comprises a plurality of components;
allocate one or more resources to the one or more components; and
modify the one or more workload parameters for the one or more components, in response to determining that one or more predetermined performance goals are not optimally supported for at least one of the plurality of network nodes.

17. The computer program product of claim 16, wherein a bin packing algorithm is used to allocate the resources to the components.

18. The computer program product of claim 16, wherein a maximum flow minimum cut algorithm is used in determining whether the one or more predetermined performance goals are not optimally supported.

19. The computer program product of claim 16, wherein modifying the one or more workload parameters for the one or more components comprises reducing the one or more workload parameters by a constant number.

20. The computer program product of claim 16, wherein modifying the one or more workload parameters for one or more components comprises reducing the one or more workload parameters by a constant percentage.
